(19) United States
(12) Patent Application Publication
(10) Pub. No.: US 2005/0020111 A1
(43) Pub. Date: Jan. 27, 2005

(54) Electrical plug safety cover

(76) Inventor: Stephen Jay Pagac, Tucson, AZ (US)

Correspondence Address: QUARLES & BRADY STREICH LANG, LLP, ONE SOUTH CHURCH AVENUE, SUITE 1700, TUCSON, AZ, 85701-1621, US

(21) Appl. No.: 10/687,044

(22) Filed: Oct. 16, 2003

Related U.S. Application Data
(63) Continuation-in-part of application No. 10/627,208, filed on Jul. 25, 2003.

(51) Int. Cl. H01R 13/44

(52) U.S. Cl. 439/134

(57) ABSTRACT

Electrical plug safety covers having a resilient sleeve that is practically unbreakable. The sleeve features a slit that opens through the application of force along a plane perpendicular to the slit, thereby allowing a plug to be easily removed from the interior of the sleeve by adults but not by small children. The invention further includes an aperture along the back of the sleeve that conforms to the shape of the cord on a plug such that the sleeve cannot easily be pulled off the plug.

### REFERENCE TO RELATED APPLICATIONS

This application is a continuation-in-part of U.S. patent application Ser. No. 10/627,208, filed on Jul. 25, 2003, by the same inventor.

### BACKGROUND

1. Field of the Invention

The invention relates in general to safety covers for electrical plugs and more particularly to a resilient sleeve that opens and closes through the application of force to two opposing sides in a plane perpendicular to a slit opening, thereby making it difficult for small children to remove and plug in an electronic device.

2. Description of the Related Art

The hazzards that electricity pose to children around the home are well known. Nonetheless, the risk of injury can be greatly amplified when unsupervised children seek to play with electrical devices or appliances that they do not know how to operate or safeguard properly. Accordingly, a child's natural curiosity and desire to imitate the actions of adults can lead to situations in which ordinary electrical items turn dangerous or even deadly.

For example, blenders, lawn trimmers, and power tools are common household possessions that would be relatively easy for a child to plug-in and actuate to his peril (and to those around him). Moreover, sensitive electrical equipment can be damaged (or made less useful by, for example, having its memory erased) if activated and not used correctly. Even appliances that are not generally thought to be inherently dangerous, such as lamps and radios, can cause burns or electric shock if touched or brought in contact with a conductive fluid. Therefore, there is an ongoing need for safety devices that prevent or discourage children from plugging in electrical appliances unless they get assistance from an adult.

U.S. Pat. No. 4,143,933 issued to Aitkins discloses a two-piece safety apparatus for attachment to the prong of an electrical connector. Essentially, a sleeve having a central channel for receiving a prong and an interior stud for engaging the hole typically (but not always) found on a prong is used to prevent one from plugging the connector into an outlet. To remove the sleeve, a key that disengages the stud from the hole must be inserted. However, if the key is lost, removal of the sleeve can be difficult.

U.S. Pat. No. 5,890,919 by Geisler describes a lock-out device for electrical plugs. The device includes a flexible bag that can be placed around a plug and locked in place through the use of a pad lock and perforated bar closing mechanism that cinches the bag shut. Again, this safety device requires the use of multiple parts that can become lost, thereby rendering the device ineffective.

U.S. Pat. No. 5,378,163 issued to Gladura et al. teaches a power tool plug safety cover that consists of two hinged pieces that snap together with internal latches over the plug, with the pieces separated through the aid of an opening tool. In addition to harboring the same disadvantage as other multi-piece covers that use “keys” to open, the device of Gladura et al. requires a user (or manufacturer) to assemble the cover on the plug and cord before it can be utilized. Also, if one of the internal latching components breaks, the device loses effectiveness.

U.S. Pat. No. 5,330,361 by Brend discloses an electrical plug locking device that includes two hemi-spherical housing elements and a keyed tumbler lock that turns an internal guide lever attached to a flexible cable. When the tumbler is turned, the cable attached to the lever disengages the prongs of the plug such that the plug can be removed from the hemi-spherical housing. While Brend's invention provides a very secure plug cover, it would also be relatively complicated to manufacture and appears to be very difficult to remove if the key is lost.

Therefore, in view of the above, it would be desirable to have an electrical plug cover that provides a secure sleeve without the need for locks or keys, that is simple for adults to engage and disengage (yet difficult for small children), and that is essentially unbreakable and inexpensive to produce.

### SUMMARY OF THE INVENTION

The invention relates in general to a plug-covering sleeve having a slit disposed on its front and an aperture formed in its back. More particularly, the invention provides a resilient sleeve that is difficult for small children to open because the sleeve requires the application of force in a plane perpendicular to the slit in order to open the sleeve sufficiently wide to disengage a plug housed by sleeve's interior.

In one embodiment, the invention is integrally formed from a single piece of resilient material, such as rubber. Thus, the plug cover of the invention is very durable and practically unbreakable under normal use. Moreover, the unitary design of the sleeve of the invention provides an advantage over related devices due to the fact that there is no key or opener to lose and no internal components to damage or break-off.

In another embodiment, one or more tabs may be disposed on two opposing surfaces of the sleeve (such as on the top and bottom) to provide additional surface area for the application of force used to open the sleeve. Also, an alternative embodiment features a dividing member on the interior of the sleeve that increases the “clamping force” present on a plug housed within the sleeve.

An further embodiment includes a resilient sleeve that has an opening slit on its front end and an aperture on its back end through which a cord runs. Preferably, the sleeve substantially conforms to the shape of the electrical plug and cord such that it cannot easily be pulled off the plug. Also preferably, fasteners (such as snaps) are provided near the back of the sleeve so that the sleeve may be conveniently installed around a plug.

Thus, it is a primary objective of the invention to provide a plug cover that is easy for adults to open but difficult for small children.

Further, an object of the invention is to provide a plug cover that is opened through the application of force along a plane perpendicular to one or more slits disposed upon the cover.

Another object of the invention is to provide a plug cover that is practically unbreakable and does not require a key or other additional components.

Still another object of the invention is to provide a plug cover that conforms to the shape of a plug and cord.

Yet another object of the invention is to provide a plug cover that is simple and inexpensive to mass produce and can be easily installed on a plug by fastening a portion of the sleeve together.

In accordance with these and other objects there is provided a new and improved plug cover that includes a resilient sleeve having a slit and an aperture disposed thereon, with the slit providing access to the interior of the sleeve through the application of force in a plane perpendicular to the slit.

Various other purposes and advantages of the invention will become clear from its description in the specification that follows. Therefore, to the accomplishment of the objectives described above, this invention includes the features hereinafter filly described in the detailed description of the preferred embodiments, and particularly pointed out in the claims. However, such description discloses only some of the various ways in which the invention may be practiced.

### BRIEF DESCRIPTION OF THE DRAWINGS

FIG. 1A is a schematic, front perspective view of a basic embodiment of the invention.

FIG. 1B is a schematic, front perspective view of the embodiment shown in FIG. 1 during the application of force that causes the slit to open and the sleeve to bow outwardly.

FIG. 2A is a schematic, front perspective view of a second embodiment as shown with an electrical plug housed within the resilient sleeve of the invention.

FIG. 2B is a schematic, front perspective view of the embodiment shown in FIG. 3 during the application of force that allows the plug to be removed from the resilient sleeve.

FIG. 3 is a schematic, front perspective view of a preferred embodiment of the invention.

FIG. 4A is a front elevational view of the embodiment of FIG. 3 shown in a bowed state.

FIG. 4B is a front elevational view of the embodiment of FIG. 3 shown in a closed state.

FIG. 5 is a front elevational view of a fourth embodiment of the invention.

FIG. 6 is a front elevational view of a fifth embodiment of the invention.

FIG. 7 is top plan view of a sixth embodiment showing the cover of the invention enclosed around an electrical plug.

FIG. 8A is a front elevational view of the embodiment shown in FIG. 7.

FIG. 8B is a front elevational view showing the application of force to the embodiment shown in FIG. 7.

FIG. 9 is a side elevational view of the embodiment shown in FIG. 7.

### DETAILED DESCRIPTION OF THE PREFERRED EMBODIMENTS

The invention involves an electrical plug safety cover and method of use featuring a resilient sleeve with at least one slit-type opening that provides access to the interior of the sleeve. By applying force to the sleeve in a plane perpendicular to the slit, the sleeve bows outwardly so that a plug may be inserted to or removed from the interior of the sleeve through the slit.

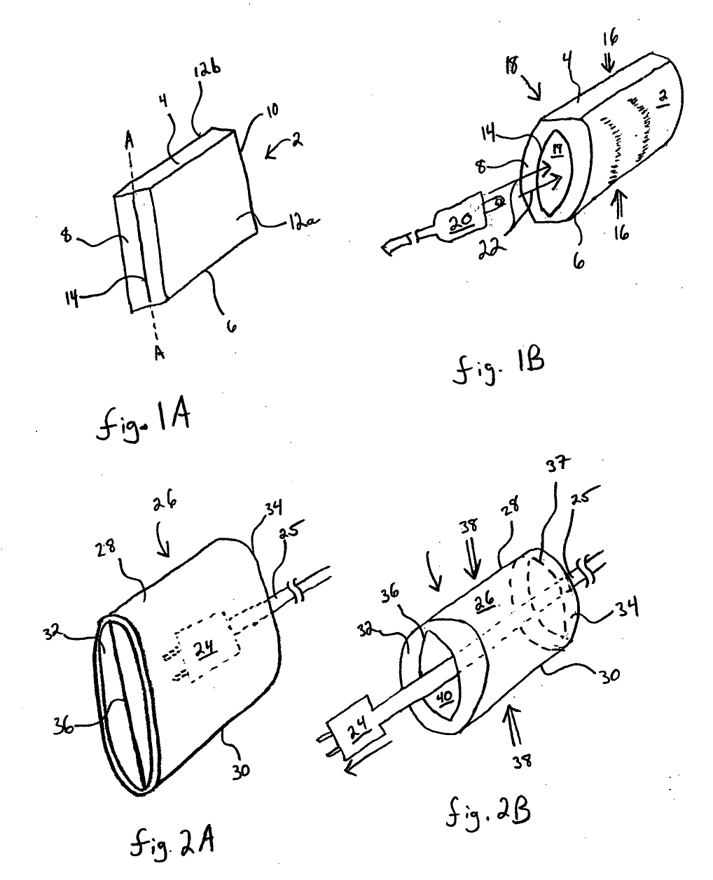

Turning to FIGS. 1A and 1B, a first embodiment of the plug cover is show. This embodiment of the invention includes a resilient sleeve 2 having a top 4, a bottom 6, a front 8, a back 10 and two opposing side walls 12a and 12b. Disposed along the front 8 of sleeve 2 is a slit 14 that defines an axis A running generally from top 4 to bottom 6. By applying force (as indicated by arrows 16 of FIG. 1A) to top 4 and bottom 6, the sleeve 2 attains a bowed state 18, which opens slit 14 and reveals the sleeve interior 19. While in the bowed state 18, a plug 20 is placed through slit 14 and in interior 19 (as indicated by arrows 22). Then, when force 16 is released, the resilient sleeve 2 returns to its original state with the plug 20 firmly clamped within (not shown).

As used throughout this application, the words “top,” “bottom,” and “sides” are used as terms of convenience and to provide consistency in describing invention. As such, these terms should be understood to be indicators of relative positions to which force is applied to engage or remove a plug from a sleeve and not indicators of a required configuration or orientation in space. Thus, while rotating the sleeve of FIG. 1 by ninety degrees would change the spatial position of the top 4 and bottom 6, it does not change where force is applied in order to open the slit 14. In other words, a sleeve of the invention can be opened by the application of force in a plane that is perpendicular to the slit or slits without regard to the name given to the parts of the sleeve to which force is applied.

As seen in FIGS. 2A and 2B, a second embodiment of the invention is depicted in which a plug 24 and a portion of its attached cord 25 are housed within a generally oval-shaped resilient sleeve 26. The sleeve 26 includes a top portion 28, a bottom portion 30, a front 32 and a back 34. Disposed within the front 32 of sleeve 26 is a first slit 36, with the sleeve also having a second slit 37 disposed within the back 34 (see FIG. 1B).

As force 38 is applied in a plane substantially perpendicular to slits 36 and 37 (i.e., to the top portion 28 and the bottom portion 30 of sleeve 26), both slits are opened such that plug 24 can be slid out of the interior 40. Moreover, after force 38 is released, the sleeve 26 may be left closed around cord 25, thereby keeping the sleeve in position for future use and preventing its loss. The interior 40 of sleeve 26 may be formed simply by the same cutting process that results in the slit or can be molded to provide a cavity more particularly adapted to receive a plug.

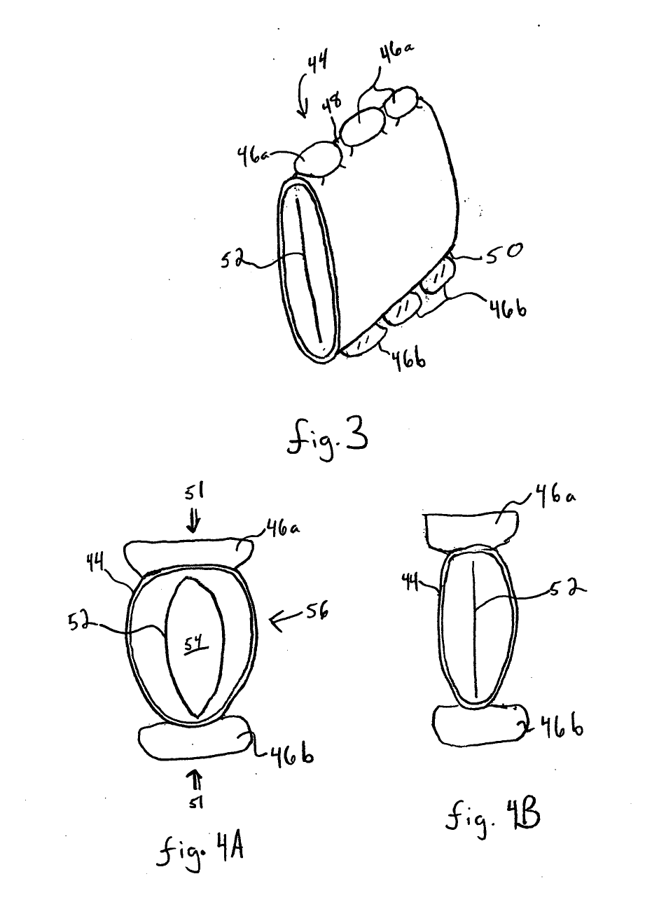

Turning to FIG. 3, a preferred embodiment of the invention is shown. Here, the resilient sleeve 44 includes tabs 46a and 46b disposed along the top portion 48 and bottom portion 50. The tabs 46a and 46b provide an enlarged surface area to which force can be applied and concentrated, making the act of opening the sleeve easier for special needs adults (e.g., those with arthritis) without increasing the ability of a small child to remove a plug therefrom.

Thus, when force 51 is applied to tabs 46a and 46b, slit 52 opens to expose interior 54, and sleeve 44 attains a bowed state 56 as shown in FIG. 4A. When force 51 is released, sleeve 44 returns to its original state (FIG. 4B).

Of course, many alternative embodiments of the novel and improved cover can be practiced without deviation from the spirit of the invention. As shown in FIG. 5, the resilient sleeve 58 further includes a dividing member 60 disposed longitudinally within interior 62. Accordingly, slit 62 does not come to a complete close, even in the absence of force to top portion 64 and bottom portion 66. The dividing member 60 provides additional clamping action on a plug and can act as a “bar” across the slit 62, thereby preventing a plug from simply being pulled out of the sleeve 58. Thus, the dividing member 60 may be disposed along the entire length (for additional clamping action) of the interior 62 or just a portion thereof (to provide a “bar”).

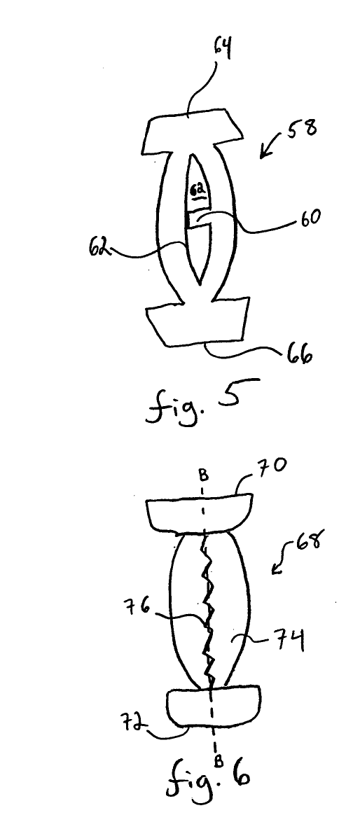

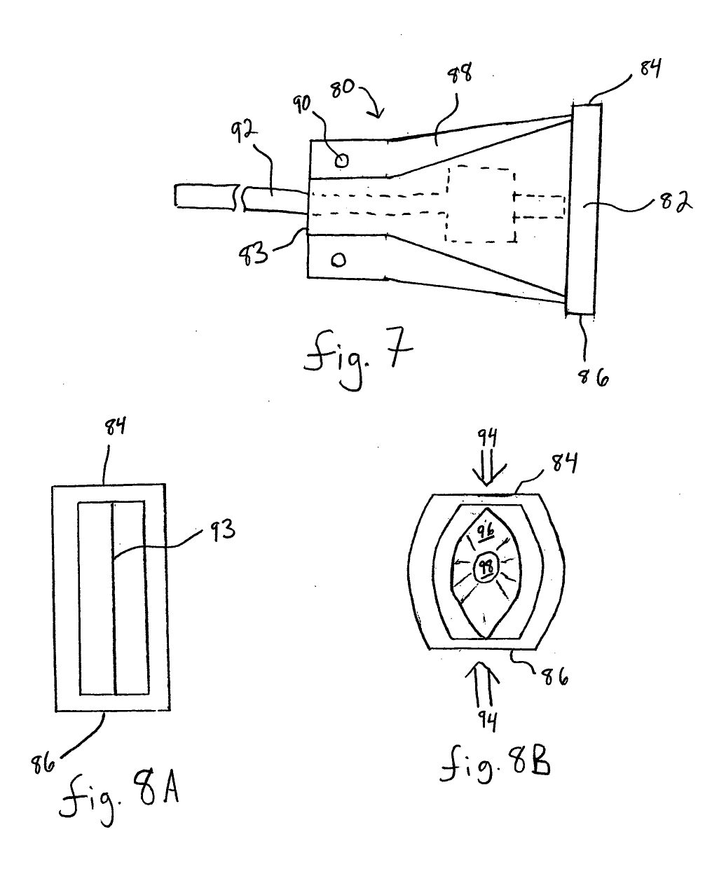

Turning to FIG. 6, another alternative embodiment is shown. Here, resilient sleeve 68 includes a top portion 70 and a bottom portion 72. Disposed upon the front 74 of sleeve 68 is a jagged slit 76. The slit 76 defines an axis B that extends from the top 70 to the bottom 72 such that the application force perpendicular to the axis B causes the sleeve 68 to bow outwardly and the slit 76 to open. The jagged configuration of the slit 76 also provides a “tooth-like” surface that may improve the retention of a plug and cord (not shown) placed inside.

In FIG. 7, an embodiment of the invention having a fastenable back portion is shown. The sleeve 80 includes a front 82, a back 83, a top 84, and a bottom 86 that together define a cavity that substantially conforms in shape to an electrical plug (shown in phantom line). Two flaps 88 are disposed between the front 82 and back 83 of sleeve 80 and contain a fastening means, such as snaps 90. The snaps 90 are used to close the back portion 83 of the sleeve 80 around the cord 92 during the sleeve installation.

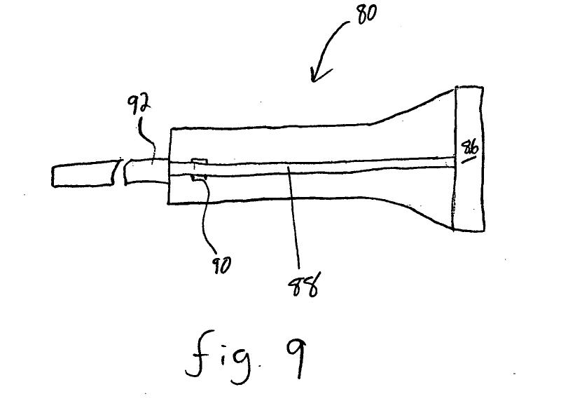

FIGS. 8A and 8B show the result of applying force 94 to the top 84 and bottom 86 of an empty sleeve 80. The slit 93 opens and the sleeve 80 achieves a bowed state, revealing the interior cavity 96 and the aperture 98 at the back 83 of the sleeve. FIG. 9 further shows sleeve 80 of FIG. 7 from a side elevational view.

Various changes in the details and components that have been described may be made by those skilled in the art within the principles and scope of the invention herein described in the specification and defined in the appended claims. For example, the sleeve of the invention may be formed (cast, molded, etc.) with any resilient material (such as, for example, rubber) rigid enough to provide sufficient clamping action on the plug while also withstanding the application of force needed to attain a bowed state without tearing or breaking. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products.

1. A cover for an electrical plug, comprising:
a resilient sleeve defining an interior adapted to receive a plug and having a top, a bottom, a front and a back;
a slit disposed along the front of the sleeve; and
an aperture disposed in the back of the sleeve,
wherein force applied to said top and said bottom causes the sleeve to bow outwardly, thereby providing access to the interior through said slit.

2. The cover of claim 1, wherein said resilient sleeve further includes a fastener disposed in proximity to said back.

3. The cover of claim 2, wherein said fastener is disposed upon a flap disposed between the front and back of said sleeve.

4. The cover of claim 2, wherein said faster comprises a snap.

5. The cover of claim 1, wherein said sleeve substantially conforms to the shape of the electrical plug housed therein.

6. A method of covering an electrical plug so that it cannot be inserted into an outlet, comprising the steps of:
(a) providing a resilient sleeve defining an interior adapted to receive a plug and having a top, a bottom, a front, a back, with a slit disposed upon the front of the sleeve and an aperture disposed in the back of the sleeve; and
(b) placing said resilient sleeve around said electrical plug.

7. The method of claim 6, wherein said resilient sleeve further includes a fastener disposed in proximity to said back such that step (b) is accomplished by fastening the sleeve around said plug.

8. The method of claim 7, wherein said fastener is disposed upon a flap disposed between the front and back of said sleeve.

9. The method of claim 7, wherein said faster comprises a snap.

10. The method of claim 6, wherein said sleeve substantially conforms to the shape of the electrical plug housed therein.
